(19) United States
(12) Patent Application Publication
(10) Pub. No.: US 2014/0006537 A1
(43) Pub. Date: Jan. 2, 2014

(54) HIGH SPEED RECORD AND PLAYBACK SYSTEM

(71) Applicants: Wiliam H. TSO, Kanata (CA); Angsuman RUDRA, Carp (CA); Dipak ROY, Ottawa (CA)

(72) Inventors: Wiliam H. TSO, Kanata (CA); Angsuman RUDRA, Carp (CA); Dipak ROY, Ottawa (CA)

(21) Appl. No.: 13/535,659

(22) Filed: Jun. 28, 2012

(51) Int. Cl. H04L 29/08

(52) U.S. Cl. CPC H04L 67/104
USPC 709/213

(57) ABSTRACT

Methods, systems, and devices for recording and playing back high speed incoming data using magnetic or solid state storage devices. Incoming data at speeds as high as 10 gb/s are first stripped of their headers and are turned into datagrams. The data stream is then sequentially routed to one of a number of software caches. The data streamed is then stored in a specific software cache and, at the same time, the data is read and transferred to its associated set of storage media. The data stream is then routed to the next software cache. Each software cache has associated with it a set of storage media. To read back the data, each associated set of media sends data to its associated software cache as the software cache sends the data to an outgoing data stream. The data throughput scales up linearly using a plurality of incoming data streams.

### TECHNICAL FIELD

The present invention relates to data recording. More specifically, the present invention relates to methods, systems, and devices for data recording from very high speed data lines.

### BACKGROUND OF THE INVENTION

The telecommunications revolution of the late 1990s and the early 2000s led to the development of fast optical communications networks. Since then, even faster networks have been developed and are now in widespread use for specific uses.

Applications which generate large amounts of data, such as medical imaging, digitized radar, high resolution data interception, and high resolution sensor applications currently use very high speed data networks to transfer data from the data production site to data storage. In some applications, these dedicated, single user high speed networks can reach speeds from 1 gigabit/sec to 10 gigabit/sec. In most of these applications, the 10 GbE (10 gigabit over Ethernet) standard is used to address the data capacity needs of the applications.

With such applications, enormous amounts of data are generated per second and transmitting that data to a recorder at acceptable speeds is only half of the equation. Since processing the data as it is generated may not be feasible nor advisable, storing that data is the only option. One major issue with storing such fast incoming data is the sheer volume of that data. Not only would large amounts of storage be needed but such storage should be fast enough to prevent incoming data from being backed up.

One option to address the above needs is to design a hardware data recorder that uses fast hardware to receive and store the incoming data. However, this approach can easily lead to an expensive solution as custom designed hardware can quite costly to design and manufacture. As well, custom designed hardware cannot be easily replaced should anything go wrong with the hardware. Finally, such custom designed hardware may also be difficult to work with, requiring custom interfaces and programming to conform the hardware with the user's needs.

There is therefore a need for solutions that allow for high speed data recording of data from a high speed data network.

### SUMMARY OF INVENTION

The present invention provides methods, systems, and devices for recording and playing back high speed incoming data using magnetic or solid state storage devices. Incoming data at speeds as high as 10 gb/s are first stripped of their headers and are turned into datagrams. The data stream is then sequentially routed to one of a number of software caches. The data streamed is then stored in a specific software cache and, at the same time, the data is read and transferred to its associated set of storage media. The data stream is then routed to the next software cache. Each software cache has associated with it a set of storage media. To read back the data, each associated set of media sends data to its associated software cache as the software cache sends the data to an outgoing data stream. The data throughput scales up linearly using a plurality of incoming data streams.

In a first aspect, the present invention provides a method for routing an incoming high speed data stream, the method comprising:
a) receiving said high speed data stream;
b) removing data packet headers from said data stream;
c) caching said streamed data, said data being cached in one of a plurality of dedicated software caches;
d) repeating step c) for each one of said plurality of dedicated software caches, said software caches being accessed in a predetermined sequential manner;
e) simultaneous with steps c) and d), transmitting cached data from said plurality of software caches to a plurality of dedicated storage media, each of said software caches being associated with at least one of said dedicated storage media, data from a storage cache being stored in storage media associated with said storage cache;
wherein only one software cache receives data from said data stream at any one time.

In a second aspect, the present invention provides a method for storing data in a plurality of storage media, said data originating from a high speed data stream, the method comprising:

a) receiving said high speed data stream;

b) removing headers from said data stream;

c) routing said data stream to a specific one of a plurality of software caches;

d) at said software cache, caching data from said data stream until said software cache reaches a predetermined fill level;

e) at said software cache and simultaneous with step d), transmitting data in said software cache to a specific one of said plurality of storage media;

f) switching a routing of said data stream to another one of said plurality of software caches when said specific one of said plurality of software caches reaches a predetermined fill level;

g) sequentially repeating steps c) to f) for each one of said plurality of software caches such that only one software cache is receiving data from said data stream at any one time.

A further aspect of the invention provides a system for storing a high-speed data stream, the system comprising:
a packetizer module for removing headers from data packets in said data stream;
a plurality of dedicated software caches for caching a data stream received from said packetizer module;
a plurality of storage media for storing data blocks derived from said data stream, each software cache being associated with at least one of said plurality of storage media;

wherein said data stream is stored using a method comprising:

a) receiving said high speed data stream;

b) removing data packet headers from said data stream using said packetizer module;

c) caching said streamed data using one of said plurality of dedicated software caches;

d) repeating step c) for each one of said plurality of dedicated software caches, said software caches being accessed in a predetermined sequential manner;

e) simultaneous with steps c) and d), transmitting cached data from said plurality of software caches to said plurality of dedicated storage media, data from a specific software cache being stored in storage media associated with said specific software cache; wherein only one software cache receives data from said data stream at any one time.

### BRIEF DESCRIPTION OF THE DRAWINGS

The embodiments of the present invention will now be described by reference to the following figures, in which identical reference numerals in different figures indicate identical elements and in which:

FIG. 1 is a block diagram of a high-speed data stream recorder system according to one aspect of the invention;

FIG. 2 is a flowchart detailing the steps in a method according to one aspect of the invention; and

FIG. 3 is a flowchart detailing the steps in another method according to a further aspect of the invention.

### DETAILED DESCRIPTION OF THE INVENTION

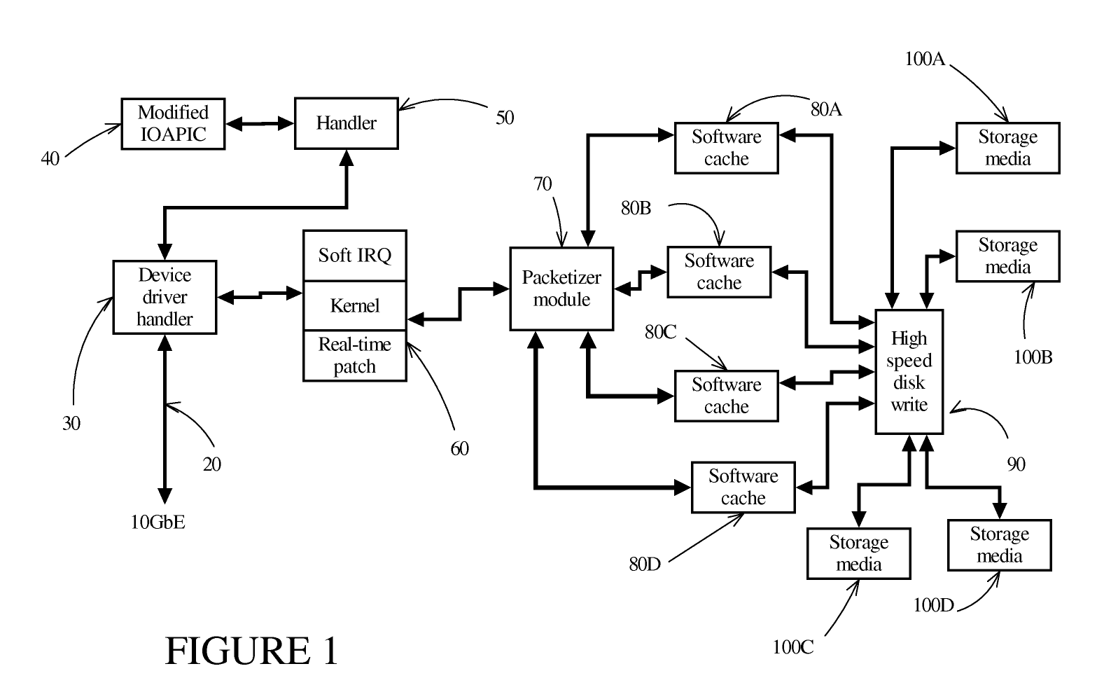

Referring to FIG. 1, a block diagram of a system according to one aspect of the invention is illustrated. The system 10 has an incoming high-speed data stream 20 which passes through a device driver handler 30 that ensures that the data is received properly. A modified I/O Advanced Programmable Interrupt Controller 40 along with a handler module 50 is present with the handler module 50 interfacing with the device driver handler 30.

The handler module 50 deals with the device driver to ensure that proper priorities are assigned to the various tasks dealt with by the device driver. For multiple CPU core implementations, this may also involve assigning which device driver tasks are to be handled by which CPU core. Once the high speed data stream has passed the device driver handler 30, the data stream then passes through a kernel block 60.

The kernel block 60 receives the data at the L2 layer.

The data is then moved to a packetizer module 70 using soft-irq without having to move the data to the L3 or L4 layer.

After passing through the kernel block 60, the data stream is then received and processed by the packetizer module 70. The packetizer module 70 removes the headers and other associated overhead data for the packets in the data stream. As an example, if the incoming data stream is an Ethernet stream, the headers associated with this protocol as well as any UDP or IP headers that may be present in the data stream. The packetizer module 70 therefore turns all the incoming packets into a single data stream. Once the data from the original data stream are in the proper format, the packetizer module 70 routes the resulting single data stream to the next stage.

The repackaging done by the packetizer module 70 removes the Ethernet, IP, and UDP headers from the incoming data packets, extracts the data and repackages that data into larger data packets. This is done on the fly as data packets arrive by way of the data stream. The speed of the repackaging is assisted by using synchronized multiple core CPUs.

The next stage in the system has a number of independent software caches 100A, 100B, 100C, and 100D. Each software cache is sequentially accessed by the packetizer 70 to receive the incoming data stream with repackaged or repacketized data. When one software cache is receiving data from the data stream, no other software caches are able or allowed to received data from the data stream. Each software cache is filled to a certain level before the data stream is rerouted to the next software cache in the sequence. The software caches can be of differing sizes but, for ease of implementation, it is preferred if all the software caches are of the same size.

After a particular software cache has been filled, that software cache sends the data it has cached to a high-speed disk write module 90 that routs the data to a specific set of storage media. There are multiple sets of storage media 100A, 100B, 100C, and 100D. Each one of these sets of storage media is associated with a specific software cache. As an example, software cache 80A is associated with storage media 100A. Each software cache can only send data to the set of storage media associated with it.

It should be noted that the system 10 in FIG. 1 is implemented in software with the sets of storage media being physical hardware that interfaces with the rest of the software system.

The software caches in FIG. 1 operate by receiving data when data is available from the data stream and transmits data to its associated set of storage media.

The packetizer module 70, as noted above, sequentially routes the repackaged data stream to the various software caches. The routing changes once a specific software cache has been filled to a predetermined fill level or a preset watermark. The predetermined fill level is a fill level that, preferably, should not be exceeded. Note that this predetermined fill level or preset watermark is not necessarily the level at which the cache is completely full. Once a specific software cache reaches its predetermined fill level, the data stream is routed to the next software cache in the sequence. As an example, in one possible sequence, the data stream could be first routed to the software cache 100A. Once that software cache reaches its predetermined fill level or preset watermark, the data stream is rerouted to the next one in the sequence, in this case software cache 100B. Of course, once the software caches have all been through the sequence, the sequence repeats with software cache 100A receiving the data stream after software cache 100D.

The data transfer from the software caches to the storage media can be done in parallel with different software caches transferring data to their associated storage media in parallel. In one implementation, this is done with higher-level software (in user space) consuming data directly from the software caches and writing that data to the xfs filing system in the relevant storage media.

It should be noted that each software cache is continuously sending data to its associated storage media as long as there is data in the storage cache to be sent, even as the software cache is receiving data from the data stream. As such, if the data stream is sending data to the software cache at a rate faster than the storage media is siphoning off that data, then the software cache will fill up. Once the software cache reaches a predetermined fill level, the data stream will then shift to send data to the next software cache in the sequence.

Once a software cache is emptied of its data and it is not next in the sequence to receive the data stream, that software cache will lie idle until it again sequentially receives the data stream. The packetizer module 70 strictly adheres to the set sequence for routing the data stream even if empty software caches are waiting. This is done specifically to preserve the order in which the software caches receive and save the data stream. The data storage scheme presented above is therefore a FIFO scheme with incoming data stored in a software cache being the first data to be passed on to the relevant storage media.

It should be noted that there is a one-to-one correspondence between the file names used to store data in the various storage media and the chronological sequence of data blocks. This is implemented to ensure proper sequencing when data is played back. One possible naming and sequencing scheme is illustrated as an example. In this naming scheme, xxxxx is either a user selected name for a recording session or a predetermined name for a specific recording section. the first two numeric values after xxxxx indicates the software cache from which the data block originates and the last numerical values in the file name relates to the overall sequencing. Thus, the first eight blocks of a data stream could be stored in storage media using the following file names:

| filenames | software cache |
|---|---|
| xxxxx_01_0000001.dta | 1 |
| xxxxx_02_0000002.dta | 2 |
| xxxxx_03_0000003.dta | 3 |
| xxxxx_04_0000004.dta | 4 |
| xxxxx_01_0000005.dta | 1 |
| xxxxx_02_0000006.dta | 2 |
| xxxxx_03_0000007.dta | 3 |
| xxxxx_04_0000008.dta | 4 |

The above file names would mean that, using a system with four software caches, the first data block originates from the first software cache, the second data block originates from the second software cache, etc., etc. After the fourth data block has been written from the fourth software cache, the next software cache in the sequence rotates back to the first software cache. The next data block, the fifth data block, is thus written from the first software cache and the sequence continues.

Using the above sequence, playback of recorded data is easier as the different file names indicate which software cache was used for caching and, hence, which storage media stores the specific data block. Depending on the playback mode, the playback can be from anywhere in the sequence. Thus, instead of starting playback from the first data block, playback can start at data block six. This means that data block 6 should be retrieved from the storage media used by software cache 2 and the rest of the data blocks subsequent to data block six can be retrieved.

To read the data from the storage media, the write sequence is repeated with the data being read instead of being written. As an example, if the last five software caches to receive data from the data stream are, in order, software cache 100B, software cache 100C, software cache 100D, software cache 100A, software cache 100B, and software cache 100C then reading the data back will simply be a matter of reading the data in the same sequence. For this example, the read back sequence will be: software cache 100B, software cache 100C, software cache 100D, software cache 100A, software cache 100B, and software cache 100C.

To reiterate the above, using the file naming convention outlined previously, if playback was desired for data from a specific time index, this can be done as long as the time index is known and which data block contains data for that time index. As an example, if the data stream from data block 4 and onwards is desired, then, from the above file naming convention, data block 4 is retrieved from the storage media for software cache 4. Data block 5 is then retrieved from the relevant storage media and so on and so forth.

When in read mode, a software cache's associated set of storage media continuously sends data to that software cache and, simultaneously, that software cache places that data on a read data stream or an outgoing data stream by way of the packetizer 70.

Once the data has been read from the software caches, the data is then repackaged with the proper headers by the packetizer module 70. The packetizer module 70 splits the large data packets, repackages the data, and adds the necessary UDP, IP, and Ethernet headers to the reconstituted packets. The repackaged data is then sent directly to the device driver 30 via the hard_xmit kernel API call. The device driver then places the repackaged data on the high speed data stream to be streamed out from the system as an output data stream.

It should be noted that each software cache receives data from either the data stream or from its associated storage media only up to a predetermined fill level. Depending on the configuration, this fill level can be any level up to completely full. Of course, depending on the circumstances, a completely full fill level may not be desirable.

It should further be noted that the software caches described above are dedicated caches pinned to the system's RAM. Each software cache is provisioned and set aside from the available physical memory of the server and is segregated such that other user or even system processes and kernel threads are not allowed to access or take over the provisioned physical memory. These caches can grow according to user application's demand.

In one implementation, the system for implementing aspects of the invention is a server with a multi-core CPU and a modified version of the Linux operating system. Among the modifications to the operating system are the provisioning for the software caches as well as a modified device handler and a module handler that assigned priorities to device handler threads and tasks. The amount of physical RAM provisioned for the software caches is configurable at provisioning and may be adjusted to suit the uses for the system.

It should be noted that the system described above is scalable with multiple incoming and outgoing high speed data streams possible. If the system is configured with, as above, four software caches per cache set, each data stream is provisioned with its own set of four software caches, each software cache being associated with a specific storage media. Thus, if there are three incoming high speed data streams, each data stream will have its own set of software caches independent of the other software caches for the other data streams. Of course, the hardware storage media will need to be shared amongst the various software caches if more storage media is not added to the system. The system can therefore linearly scale its input speed with the number of incoming data streams on different fiber cables. As an example, the system can receive one 10 GbE fiber and its input speed would be 10 Gb/s. However, it can also receive an extra 2 fiber inputs of 10 GbE to thereby scale its input speed to 30 Gb/s. Of course, lower speed inputs can also be accommodated. One reason for such scalability is that identical dedicated software cache sets are provisioned for each incoming inputs. It should be noted that time-correlated packets coming from different 10 Gb links can be played back in the same time-correlated manner.

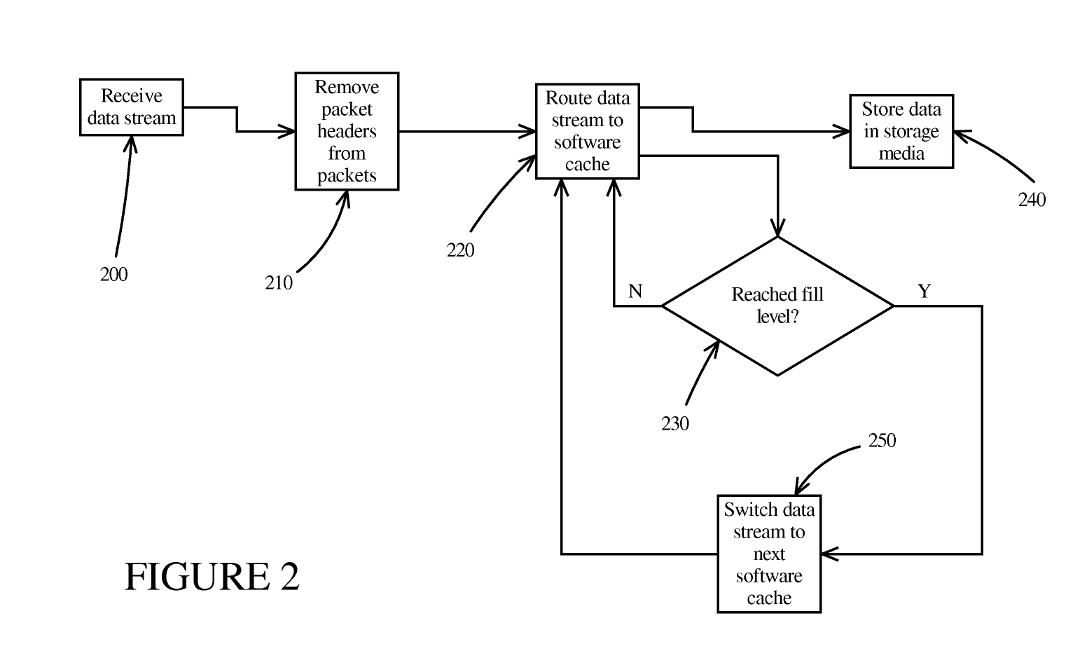

Referring to FIG. 2, a flowchart detailing the steps in a method according to one aspect of the invention is illustrated. The method begins at step 200, that of receiving the incoming high speed data stream. The high speed data stream is then processed and the packet headers are removed from the data packets (step 210) to result in another data stream. This data stream is then routed to one of multiple software data caches (step 220). The next step (step 230) then checks if the software cache has reached its predetermined fill level. If not, then the data stream continues. Simultaneous with checking the software cache's capacity, the data streamed into the software cache is transmitted for storage in an associated storage media (step 240). If step 230 determines that the software cache has reached its predetermined fill level, then the data stream is switched to the next software cache in the sequence (step 250). The logic flow then returns to step 230 to continue the data stream to this next software cache.

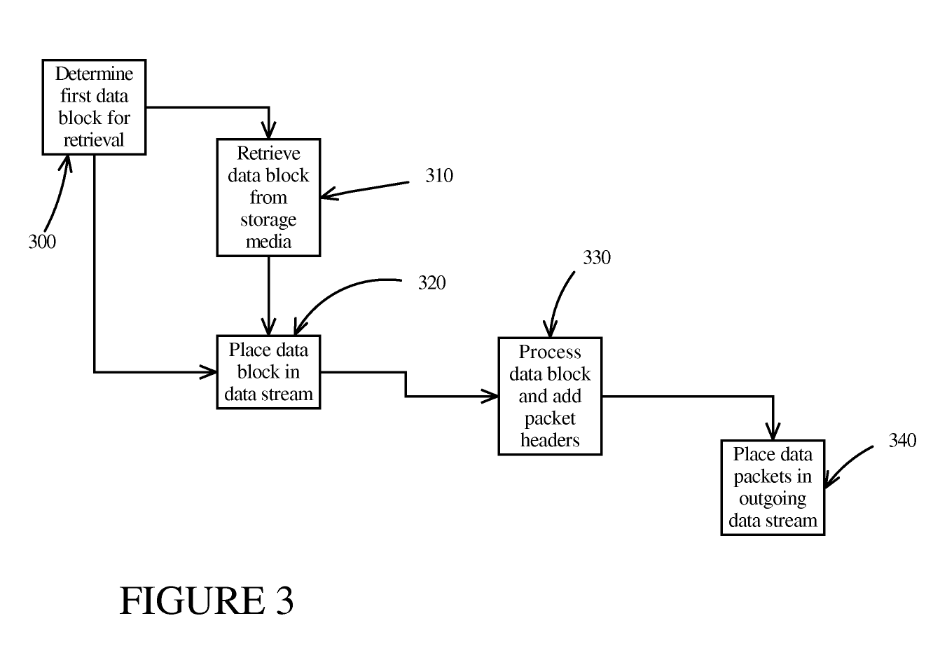

For playback or retrieval of the data stored in the storage media, FIG. 3 is a flowchart detailing the steps in a method for the data retrieval. Step 300 is that of determining the first data block for retrieval. This may be done by determining which time index is desired and correlating the time index with a specific stored data block in one of the storage media. Step 310 then retrieves the relevant data block from one of the storage media and caching it in an associated software cache. Simultaneous with retrieving the relevant data block, the data cached in the software block is placed on a data stream (step 320). The data stream is then processed and the relevant data packet headers are inserted to result in data packets (step 330). The reconstituted data packets are then placed on an outgoing data stream (step 340) which is output from the system.

It should also be noted that the storage media used in the system as described above may be solid state (i.e. solid state drives or SSD) or may be conventional magnetic (spinning) hard drives. Alternatively, the storage media used may be a combination of the two.

The method steps of the invention may be embodied in sets of executable machine code stored in a variety of formats such as object code or source code. Such code is described generically herein as programming code, or a computer program for simplification. Clearly, the executable machine code may be integrated with the code of other programs, implemented as subroutines, by external program calls or by other techniques as known in the art.

The embodiments of the invention may be executed by a computer processor or similar device programmed in the manner of method steps, or may be executed by an electronic system which is provided with means for executing these steps. Similarly, an electronic memory means such computer diskettes, CD-Roms, Random Access Memory (RAM), Read Only Memory (ROM) or similar computer software storage media known in the art, may be programmed to execute such method steps. As well, electronic signals representing these method steps may also be transmitted via a communication network.

Embodiments of the invention may be implemented in any conventional computer programming language For example, preferred embodiments may be implemented in a procedural programming language (e.g.“C”) or an object oriented language (e.g.“C++”, “java”, or “C#”). Alternative embodiments of the invention may be implemented as pre-programmed hardware elements, other related components, or as a combination of hardware and software components.

Embodiments can be implemented as a computer program product for use with a computer system. Such implementations may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or electrical communications lines) or a medium implemented with wireless techniques (e.g., microwave, infrared or other transmission techniques). The series of computer instructions embodies all or part of the functionality previously described herein. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink wrapped software), preloaded with a computer system (e.g., on system ROM or fixed disk), or distributed from a server over the network (e.g., the Internet or World Wide Web). Of course, some embodiments of the invention may be implemented as a combination of both software (e.g., a computer program product) and hardware. Still other embodiments of the invention may be implemented as entirely hardware, or entirely software (e.g., a computer program product).

A person understanding this invention may now conceive of alternative structures and embodiments or variations of the above all of which are intended to fall within the scope of the invention as defined in the claims that follow.

We claim:

1. A method for routing an incoming high speed data stream for storage and playback, the method comprising:
a) receiving said high speed data stream;
b) removing data packet headers from said data stream to produce streamed data;
c) caching said streamed data, said data being cached in a set of dedicated software caches, said set of dedicated software caches comprising a plurality of dedicated software caches;
d) repeating step c) for each one of said plurality of dedicated software caches, said software caches being accessed in a predetermined sequential manner;
e) simultaneous with steps c) and d), transmitting cached data from said plurality of software caches to a plurality of dedicated storage media, each of said software caches being associated with at least one of said dedicated storage media, data from a storage cache being stored in storage media associated with said storage cache;
wherein only one software cache receives data from said data stream at any one time.

2. A method according to claim 1 wherein each software cache transmits data to its associated dedicated storage media while said software cache receives data from said data stream.

3. A method according to claim 1 wherein data is stored in said dedicated storage media using file names which preserve a sequence of data blocks derived from said data stream.

4. A method according to claim 1 wherein said data stream is switched from a first software cache to a second software cache once said first software cache has reached a predetermined fill level.

5. A method according to claim 1 further comprising the steps of:
receiving at least one other high speed data stream;
for each of said at least one other high speed data stream, provisioning another set of dedicated software caches.

6. A method according to claim 1 wherein said data stored in said storage media is played back according to a playback method comprising:
a1) retrieving a data block from one of said plurality of storage media;
b1) transmitting said data block to one of said plurality of dedicated software caches associated with said storage media;
c1) caching said data block at said one of said plurality of dedicated software caches;
d1) streaming said data block to said packetizer module;
e1) adding data packet headers to said data using said packetizer module;
f1) placing said data on an outgoing data stream;
repeating steps a1)-f1) for each data block to be retrieved, said data blocks being retrieved in a same order as said data blocks were stored.

7. A method for storing data in a plurality of storage media and playing back said data, said data originating from an incoming high speed data stream, the method comprising:
a) receiving said incoming high speed data stream;
b) removing headers from said incoming data stream;
c) routing said data stream to a specific one of a plurality of dedicated software data caches;
d) at said software data cache, caching data from said data stream until said software data cache reaches a predetermined fill level;
e) at said software data cache and simultaneous with step d), transmitting data in said software data cache to a specific one of said plurality of storage media;
f) switching a routing of said data stream to another one of said plurality of software data caches when said specific one of said plurality of software data caches reaches a predetermined fill level;
g) sequentially repeating steps c) to f) for each one of said plurality of software data caches such that only one software data cache is receiving data from said data stream at any one time.

8. A method according to claim 7 wherein each software cache transmits data to its associated dedicated storage media while said software cache receives data from said data stream.

9. A method according to claim 7 wherein data is stored in said dedicated storage media using file names which preserve a sequence of data blocks derived from said data stream.

10. A method according to claim 7 wherein said data is played back using a method comprising:
a1) retrieving a data block from one of said plurality of storage media;
b1) transmitting said data block to one of said plurality of dedicated software data caches associated with said storage media;
c1) caching said data block at said one of said plurality of dedicated data software caches;
d1) adding data packet headers to said data;
f1) placing said data on an outgoing data stream;
repeating steps a1)-f1) for each data block to be retrieved, said data blocks being retrieved in a same order as said data was stored.

11. A method according to claim 7 wherein said method further comprises:
receiving at least one other incoming high speed data stream;
for each of said at least one other high speed data stream, provisioning another set of dedicated software caches.

12. A system for use in storing recording and playing back at least one high-speed data stream, the system comprising:
a packetizer module for removing headers from data packets in an incoming data stream;
a plurality of dedicated software caches for caching a data stream received from said packetizer module;
a plurality of storage media for storing data blocks derived from said data stream, each software cache being associated with at least one of said plurality of storage media;
wherein said data stream is stored using a method comprising:
a) receiving said high speed data stream;
b) removing data packet headers from said data stream using said packetizer module;
c) caching said streamed data using one of said plurality of dedicated software caches;
d) repeating step c) for each one of said plurality of dedicated software caches, said software caches being accessed in a predetermined sequential manner;
e) simultaneous with steps c) and d), transmitting cached data from said plurality of software caches to said plurality of dedicated storage media, data from a specific software cache being stored in storage media associated with said specific software cache;
wherein only one software cache receives data from said data stream at any one time.

13. A system according to claim 12 wherein each software cache transmits data to its associated dedicated storage media while said software cache receives data from said data stream.

14. A system according to claim 12 wherein data is stored in said dedicated storage media using file names which preserve a sequence of data blocks derived from said data stream.

15. A system according to claim 12 wherein said data stream is switched from a first software cache to a second software cache once said first software cache has reached a predetermined fill level.

16. A system according to claim 12 wherein said wherein said data stream is played back using a method comprising:
a1) retrieving a data block from one of said plurality of storage media;
b1) transmitting said data block to one of said plurality of dedicated software caches associated with said storage media;
c1) caching said data block at said one of said plurality of dedicated software caches;
d1) streaming said data block to said packetizer module;
e1) adding data packet headers to said data using said packetizer module;
f1) placing said data on an outgoing data stream;
repeating steps a1)-f1) for each data block to be retrieved, said data blocks being retrieved in a same order as said data blocks were stored.

17. A system according to claim 16 wherein each one of said software caches simultaneously receives said data block and transmits said data block to said packetizer module when said data stream is retrieved.

18. A system according to claim 12 wherein said method further comprises:
receiving at least one other high speed data stream;
for each of said at least one other high speed data stream, provisioning another set of dedicated software caches.

19. A system according to claim 12 wherein said plurality of storage media comprises magnetic media.

20. A system according to claim 12 wherein said plurality of storage media comprises solid state storage media.

21. Computer readable media having encoded thereon computer readable and computer executable instructions which, when executed, implements a method for routing an incoming high speed data stream for storage and playback, the method comprising:
a) receiving said high speed data stream;
b) removing data packet headers from said data stream to produce streamed data;
c) caching said streamed data, said data being cached in a set of dedicated software caches, said set of dedicated software caches comprising a plurality of dedicated software caches;
d) repeating step c) for each one of said plurality of dedicated software caches, said software caches being accessed in a predetermined sequential manner;
e) simultaneous with steps c) and d), transmitting cached data from said plurality of software caches to a plurality of dedicated storage media, each of said software caches being associated with at least one of said dedicated storage media, data from a storage cache being stored in storage media associated with said storage cache;
wherein only one software cache receives data from said data stream at any one time.
